(19) United States
(12) Patent Application Publication
(10) Pub. No.: US 2013/0297535 A1
(43) Pub. Date: Nov. 7, 2013

(54) METHOD AND APPARATUS FOR PRESENTING CLOUD-BASED REPOSITORIES BASED ON LOCATION INFORMATION

(71) Applicants: Dhaval Jitendra Joshi, Bangalore (IN); Vijay Narayanan-Saroja, Bangalore (IN); Ari Antero Aarnio, Espoo (FI)

(72) Inventors: Dhaval Jitendra Joshi, Bangalore (IN); Vijay Narayanan-Saroja, Bangalore (IN); Ari Antero Aarnio, Espoo (FI)

(73) Assignee: NOKIA CORPORATION, Espoo (FI)

(21) Appl. No.: 13/886,116

(22) Filed: May 2, 2013

(30) Foreign Application Priority Data
May 4, 2012 (IN) 1738/CHE/2012

(51) Int. Cl. G06F 3/0484

(52) U.S. Cl. CPC G06F 3/0484
USPC 705/400; 715/738

(57) ABSTRACT

An approach is provided for presenting cloud-based repositories based on location information. The cloud-based storage platform determines location information associated with one or more cloud-based repositories that include data associated with at least one user. Next, the cloud-based storage platform causes, at least in part, a presentation of a user interface depicting one or more representations of the one or more cloud-based repositories based, at least in part, on the location information.

### BACKGROUND

Service providers and device manufacturers (e.g., wireless, cellular, etc.) are continually challenged to deliver value and convenience to consumers by, for example, providing compelling network services. Cloud-based storage, for instance, is one such service that is increasingly gaining popularity. However, typical approaches to cloud-based storage does not allow users to know very much about the data storage, including where the user data will be stored, other data that the user data will be stored with, etc. As such, the “cloud” is but a dark hole where the user has no insight with respect to its storage function.

### SOME EXAMPLE EMBODIMENTS

Therefore, there is a need for an approach for presenting cloud-based repositories based on location information.

According to one embodiment, a method comprises determining location information associated with one or more cloud-based repositories that include data associated with at least one user. The method also comprises causing, at least in part, a presentation of a user interface depicting one or more representations of the one or more cloud-based repositories based, at least in part, on the location information.

According to another embodiment, an apparatus comprises at least one processor, and at least one memory including computer program code for one or more computer programs, the at least one memory and the computer program code configured to, with the at least one processor, cause, at least in part, the apparatus to determine location information associated with one or more cloud-based repositories that include data associated with at least one user. The apparatus is also caused to cause, at least in part, a presentation of a user interface depicting one or more representations of the one or more cloud-based repositories based, at least in part, on the location information.

According to another embodiment, a computer-readable storage medium carries one or more sequences of one or more instructions which, when executed by one or more processors, cause, at least in part, an apparatus to determine location information associated with one or more cloud-based repositories that include data associated with at least one user. The apparatus is also caused to cause, at least in part, a presentation of a user interface depicting one or more representations of the one or more cloud-based repositories based, at least in part, on the location information.

According to another embodiment, an apparatus comprises means for determining location information associated with one or more cloud-based repositories that include data associated with at least one user. The apparatus also comprises means for causing, at least in part, a presentation of a user interface depicting one or more representations of the one or more cloud-based repositories based, at least in part, on the location information.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-11, 23-33, and 39-41.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of presenting cloud-based repositories based on location information, according to one embodiment;

FIG. 2 is a diagram of the components of a cloud-based storage platform, according to one embodiment;

FIG. 3 is a flowchart of a process for presenting cloud-based repositories based on location information, according to one embodiment;

FIG. 4 is a flowchart of a process for storing data based on a location and an entity of interest, according to one embodiment;

FIG. 5 is a flowchart of a process for transferring data to other cloud-based repositories, according to one embodiment;

FIGS. 6A-6E are diagrams of scenarios utilizing presentation of cloud-based repositories, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for presenting cloud-based repositories based on location information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

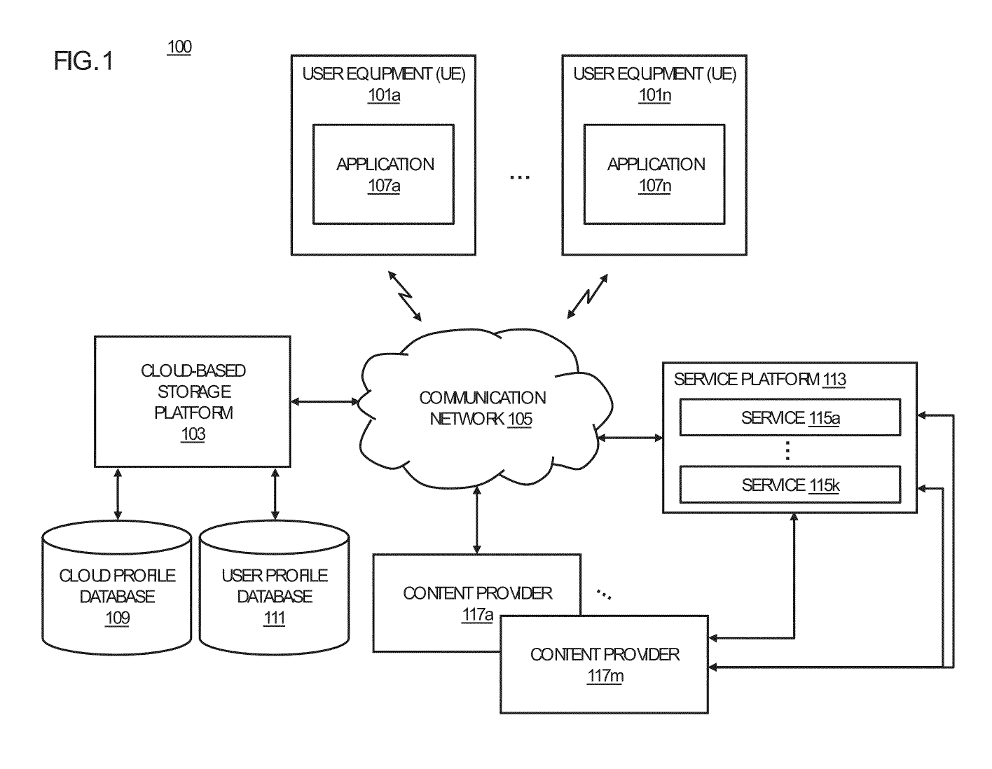

FIG. 1 is a diagram of a system capable of presenting cloud-based repositories based on location information, according to one embodiment. As discussed, cloud-based storage is a service that is increasingly gaining popularity. However, users are generally not provided with information that enables them to know where their files will be stored, other files that their files will be stored with, other files that their files will be close to, etc. In addition, there have been many cases where personal information of users are compromised at cloud-based data centers, decreasing user confidence of such cloud-based storage services. Because of these data integrity issues and the lack of information, the “cloud” is but a dark hole where the user has no insight with respect to its storage function.

To address this problem, a system 100 of FIG. 1 introduces the capability to present cloud-based repositories based on location information. By way of example, the system 100 may determine location information associated with one or more cloud-based repositories that include data associated with a user. The system 100 may then cause a presentation of a user interface depicting representations of the cloud-based repositories based on the location information. In one scenario, the location of a cloud-based repository storing data associated with a particular user may be determined. In addition, the locations of other cloud-based repositories storing other data associated with other users may be determined. The locations of the cloud-based repository and the other cloud-based repositories may then be utilized to render representations of the cloud-based repositories on a map user interface to illustrate the proximity (although not necessarily to scale) of the cloud-based repository to the other cloud-based repositories. The map user interface may, for instance, enable the user to browse all of the cloud-based repositories in the area along with other cloud-based repositories in other areas. In certain embodiments, the map user interface may also provide additional information about the cloud-based repositories, such as the various physical addresses of the cloud-based repositories, the identity of the other users who store data at the cloud-based repositories, events associated with the cloud-based repositories, etc. In this way, the system 100 enables users to visualize and browse the cloud-based repositories. In addition, users are able to see where their data is stored, increasing transparency and confidence of the users.

As shown in FIG. 1, the system 100 comprises a user equipment (UE) 101 (or multiple UEs 101a-101n) having connectivity to a cloud-based storage platform 103 via a communication network 105. The UE 101 may include or have access to an application 107 (e.g., applications 107a-107n) to enable the UE 101 to interact with, for instance, the cloud-based storage platform 103, which may: (1) determine location information associated with one or more cloud-based repositories that include data associated with at least one user; (2) present a user interface depicting one or more representations of the cloud-based repositories based on the location information; (3) store the data at the cloud-based repositories based on the location information; (4) determine one or more entities of interest storing other data at the cloud-based repositories; (5) present endorsement information, social networking information, and/or performance information associated with the cloud-based repositories in the user interface; (6) present other cloud-based repositories that are available to store the data in the user interface for selection by the user; (7) transmit the data from the cloud-based repositories to at least one of the other cloud-based repositories (e.g., based on an input for selecting the other cloud-based repository, a transfer of the other data associated with the entities of interest to the other cloud-based repository, etc.); (8) charge for the storage at the cloud-based repositories based on payment information associated with the entities of interest and/or the location information; or (9) perform other functions.

In various embodiments, the cloud-based storage platform 103 may include or have access to a cloud profile database 109 to access or store location information, endorsement information, social networking information, performance information, entity of interest information, user information, payment information, etc., associated with the cloud-based repositories. The cloud-based storage platform 103 may also include or have access to a user profile database 111 to access or store account information associated with users (e.g., user identification, data specifying respective cloud-based repositories utilized by the users, history information of the users, etc.). Data stored in the cloud profile database 109 and the user profile database 111 may, for instance, be provided by the UEs 101, a service platform 113, one or more services 115 (or services 115a-115k), one or more content providers 117 (or content providers 117a-117m), and/or other services available over the communication network 105. For example, a certain service 115 may provide location information associated with the cloud-based repositories to the cloud-based storage platform 103. It is noted that the cloud-based storage platform 103 may be a separate entity of the system 100, a part of the one or more services 115 of the service platform 113, or included within the UE 101 (e.g., as part of the application 107).

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In another embodiment, the cloud-based storage platform 103 may cause, at least in part, a storage of the data at the one or more cloud-based repositories based, at least in part, on the location information. In one use case, a user may select a particular region (e.g., Hawaii, within 10 miles of City X, etc.) to store her data. As such, the cloud-based storage platform 103 may determine cloud-based repositories within that selected region and present the cloud-based repositories to the user according to the location information of the cloud-based repositories. Thus, the user may select one or more of the presented cloud-based repositories to store her data (e.g., primary storage, backup storage, etc.).

In another embodiment, the cloud-based storage platform 103 may determine one or more entities of interest storing other data at the one or more cloud-based repositories, wherein the storage of the data at the one or more cloud-based repositories is further based, at least in part, on the one or more entities of interest. In one scenario, John may be a fan of Michael Zackson and Tom Cruize, and, thus, may request to store his data in cloud-based repositories in which Michael Zackson or Tom Cruize store their data. To satisfy John's request, the cloud-based storage platform 103 may determine that Michael Zackson stores his data in Cloud Repository MZ and that Tom Cruize stores his data in Cloud Repository TC. This information may then be presented to John in a user interface depicting representations of Cloud Repositories MZ and TC (e.g., clouds depicting Michael Zackson's and Tom Cruize's names and faces). As a result, John may select Cloud Repository MZ to store his primary data and Cloud Repository TC to store his backup data. In another scenario, John may select to store his data near either Michael Zackson's data or Tom Cruize's data. Consequently, the cloud-based storage platform 103 may automatically determine to store John's primary data in a cloud-based repository that is near a cloud-based repository storing Michael Zackson's primary data, and determine to store John's backup data in a cloud-based repository that is near a cloud-based repository storing Tom Cruize's backup data.

In another embodiment, the cloud-based storage platform 103 may cause, at least in part, a presentation of endorsement information, social networking information, performance information, or a combination thereof associated with the one or more cloud-based repositories in the user interface. In a further embodiment, the endorsement information, the social networking information, the performance information, or a combination thereof may specify, at least in part, one or more associations between the one or more entities and the one or more cloud-based repositories. By way of example, when the representations of the cloud-based repositories are presented to a user, the representations may include the endorsement information (e.g., an endorsement of a celebrity), the social networking information (e.g., friends within a social networking group of the user), and/or the performance information (e.g., performance of servers storing data belonging to the celebrity, the social networking friends, etc.). In one use case, the user interface may depict clouds that represent the cloud-based repositories based on their respective locations. In addition, a cloud may include names of celebrities, social networking friends, etc., who store their data at a cloud-based repository associated with that cloud. Thus, a user may, for instance, elect to store her data (e.g., media, documents, etc.) near files belonging to a particular celebrity by browsing the various clouds and selecting the cloud with the celebrity's name.

In another embodiment, the cloud-based storage platform 103 may determine one or more other cloud-based repositories that are available to store the data. The cloud-based storage platform 103 may then cause, at least in part, a presentation of the one or more other cloud-based repositories in the user interface for selection by the at least one user. As indicated, a user interface depicting cloud-based repositories that store data associated with a user may be presented to that user. In addition, other cloud-based repositories that store data of other users may be depicted on the user interface (e.g., based on their respective locations). In some cases, the rendering of the other cloud-based repositories may also be based on their availability to store the data belonging to the user (e.g., sufficient memory to store the user's entire data collection, to store a portion of the user's data collection, etc.).

In another embodiment, the cloud-based storage platform 103 may cause, at least in part, a transmission of the data from the one or more cloud-based repositories to at least one of the one or more other cloud-based repositories. In a further embodiment, the cloud-based storage platform 103 may determine an input for selecting the at least one of the one or more other cloud-based repositories, wherein the transmission is based, at least in part, on the selection input. As indicated, in one scenario, a user interface depicting various clouds representing cloud-based repositories may be presented to a user. Although the user may initially already have his cloud-based files stored at a particular cloud-based repository, the user may decide that he wants to store his files at the same cloud-based repository as his favorite actress. As such, the user may browse the various clouds on the user interface to find a cloud representing a cloud-based repository in which his favorite actress stores her files. Once the user finds the desired cloud, he may then select an option on the cloud to store his files at the cloud-based repository associated with the actress. As a result, the files that are currently stored at the initial cloud-based repository may be transferred to the cloud-based repository associated with the actress.

In another embodiment, the cloud-based storage platform 103 may determine a transfer of the other data associated with the one or more entities of interest to the at least one of the one or more other cloud-based repositories, wherein the transmission is based, at least in part, on the transfer of the other data. In one use case, Kevin may be a user of a cloud-based storage service who has elected to store all of his cloud-based files near Michael Zackson's cloud-based files. As an example, Kevin's files may currently be stored at the same cloud-based repository as Michael Zackson's files along with other files of other users that also want to store their files near Michael Zackson's files. Because of Kevin's election, his files may automatically be moved or transferred based on the real-time location of Michael Zackson's files. If, for instance, Michael Zackson moves all of his cloud-based files from the current cloud-based repository to a new cloud-based repository, the file move may trigger the transfer of Kevin's files to the new cloud-based repository so that Kevin's files stay close to Michael Zackson's files.

In another scenario, the new cloud-based repository may not be available to store Kevin's files after Michael Zackson's files are stored at the new cloud-based repository (e.g., Michael Zackson may have a lot of files, the new cloud-based repository may have become full from storing files of other Michael Zackson fans that transferred with Michael Zackson's file move, etc.). As a result, Kevin's files may be transmitted to another cloud-based repository that is still physically close to the new cloud-based repository (e.g., within a predetermined threshold distance of the new cloud-based repository).

In another embodiment, the cloud-based storage platform 103 may determine payment information associated with the one or more entities of interest, the location information, or a combination thereof. The cloud-based storage platform 103 may then determine to charge for the storage at the one or more cloud-based repositories based, at least in part, on the payment information. By way of example, a particular cloud-based service may have signed a contract with Tom Cruize to store his files at cloud-based repositories associated with that cloud-based service. As such, the cloud-based service may pass the cost of the contract to its users in premium rates for storing their cloud-based files at cloud-based repositories containing Tom Cruize's files. By way of another example, the cloud-based service may have signed a contract with Tom Cruize to store a cloud-based repository in Tom Cruize's house. Thus, the cloud-based service may charge users a premium rate for storing their files at Tom Cruize's house. In this way, fans of Tom Cruize may be “closer” to Tom Cruize (e.g., stronger emotional connection) since their files are stored with Tom Cruize's files, stored at Tom Cruize's house, etc.).

In another embodiment, the cloud-based storage platform 103 may determine one or more requests to store the data at the one or more cloud-based repositories based, at least in part, on a determination that at least one event will utilize stored data at the one or more cloud-based repositories. In one scenario, a famous disc jockey (DJ) may be selecting and playing recorded music at a big show. A cloud-based storage service provider sponsoring the big show may, for instance, promote their cloud-based repositories by telling its users (and potential users) that the famous DJ will exclusively be playing music that is stored on cloud-based repositories associated with that service. Users may then transfer their files from other cloud-based repositories to the cloud-based repositories associated with the sponsoring cloud-based storage service provider for a chance to have their music played at the big show. In a further scenario, such transfers, storage, etc., of the users' data may be automatic based on one or more account settings of those users. For example, songs written by a user may automatically be transferred to a cloud-based storage when the cloud-based storage platform 103 determines that an event will play songs stored at that cloud-based repository. Thus, in one embodiment, the cloud-based storage platform 103 may enable services to promote their cloud-based repositories, enable services or users to promote their work or the work of others, etc.

By way of example, the UE 101, the cloud-based storage platform 103, the service platform 113, the services 115, and the content providers 117 communicate with each other and other components of the communication network 105 using well known, new or still developing protocols. In this context, a protocol includes a set of rules defining how the network nodes within the communication network 105 interact with each other based on information sent over the communication links The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

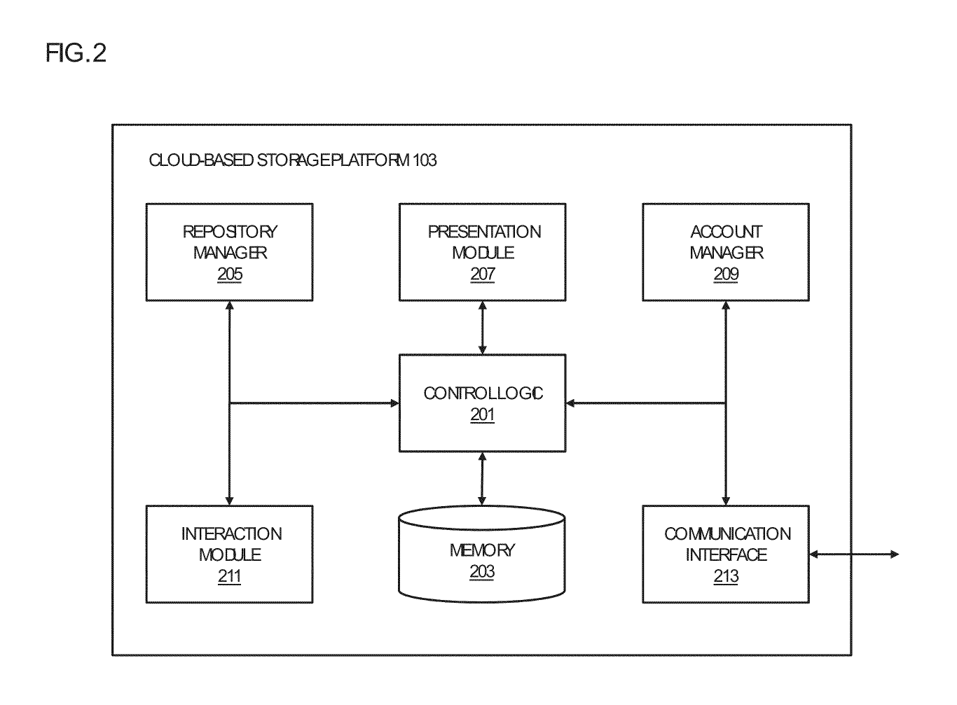

FIG. 2 is a diagram of the components of a cloud-based storage platform, according to one embodiment. By way of example, the cloud-based storage platform 103 includes one or more components for presenting cloud-based repositories based on location information. It is contemplated that the functions of these components may be combined in one or more components or performed by other components of equivalent functionality. In this embodiment, the cloud-based storage platform 103 includes control logic 201, memory 203, a repository manager 205, a presentation module 207, an account manager 209, an interaction module 211, and a communication interface 213.

The control logic 201 executes at least one algorithm for executing functions of the cloud-based storage platform 103. For example, the control logic 201 may interact with the repository manager 205 to determine location information associated with one or more cloud-based repositories that include data associated with a user. As indicated, in some embodiments, the repository manager 205 may have stored the data associated with the user at the cloud-based repositories based on the location information (e.g., the physical addresses of the cloud-based repositories, the proximity of the cloud-based repositories to files of a social networking friend, etc.).

The repository manager 205 may, for instance, work with the presentation module 207 to present a user interface depicting representations of the cloud-based repositories based on the location information. In one use case, the user interface may depict clouds over various regions of the world in which the user's files are stored (e.g., the clouds may represent the cloud-based repositories in which the files are stored). In certain embodiments, the repository manager 205 may also interact with the presentation module 207 to present endorsement information, social networking information, and/or performance information associated with the cloud-based repositories in the user interface. For example, the repository manager 205 may determine the entities of interest who store their data at each of the cloud-based repositories and the presentation module 207 may provide the identity of those entities of interest as the endorsement information and/or the social networking information to entice users to select particular cloud-based repositories for storage of their data (e.g., “Lady Dada stores her data here! Store your data with Lady Dada!”).

The control logic 201 may also employ the account manager 209 to determine account settings associated with the user, other users, entities of interest, etc. In one scenario, for instance, the account manager 209 may determine that the user has an account setting requiring that all of the user's cloud-based files follow Lady Dada's cloud-based files. Thus, if it is determined that Lady Dada's cloud-based files has been transferred to a new cloud-based repository, the account manager 209 may work with the repository manager 205 to transfer the user's cloud-based files to the new cloud-based repository (e.g., based on the storage availability of the new cloud-based repository). In addition, the control logic 201 may direct the interaction module 211 to perform certain actions upon detecting particular user interactions. For example, if it is detected that the user is attending an event that will utilize music from a particular cloud-based repository, the interaction module 211 may trigger the repository manager 205 to transmit the user's written music to that cloud-based repository to increase the chances that the user's music will be played at that event.

The control logic 201 may additionally utilize the communication interface 213 to communicate with other components of the cloud-based storage platform 103, the UEs 101, the service platform 113, the services 115, the content providers 117, and other components of the system 100. For example, the communication interface 213 may be utilized to receive selection data (e.g., selection of a cloud to store the user's data at the cloud-based repository associated with the cloud) from the UEs 101. The communication interface 213 may further include multiple means of communication. In one use case, the communication interface 213 may be able to communicate over short message service (SMS), multimedia messaging service (MMS), internet protocol, email, instant messaging, voice sessions (e.g., via a phone network), or other types of communication.

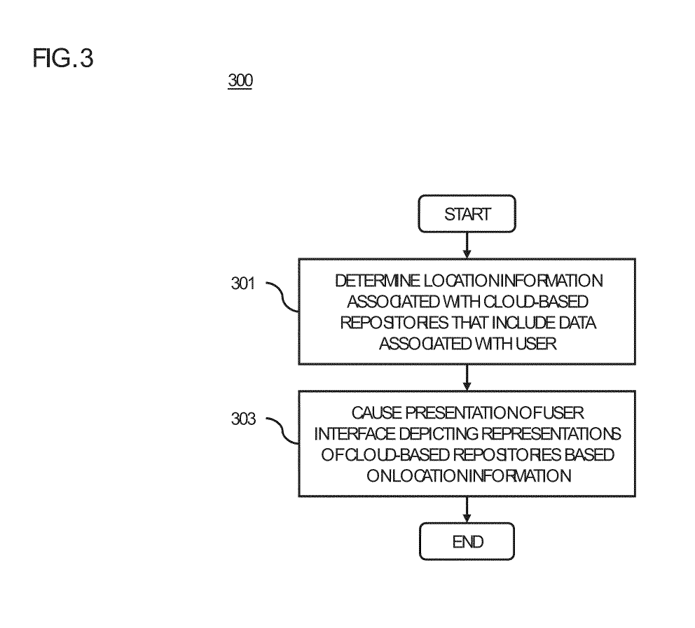

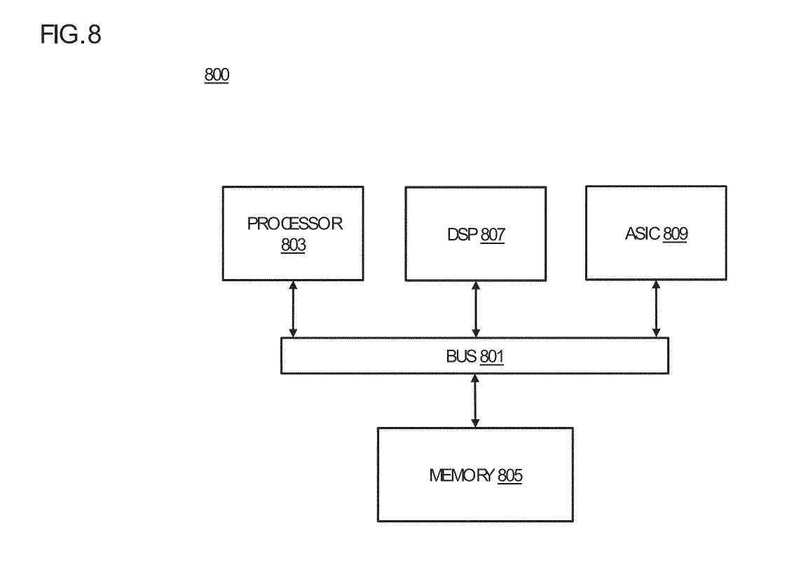

FIG. 3 is a flowchart of a process for presenting cloud-based repositories based on location information, according to one embodiment. In one embodiment, the cloud-based storage platform 103 performs the process 300 and is implemented in, for instance, a chip set including a processor and a memory as shown in FIG. 8. As such, the control logic 201 can provide means for accomplishing various parts of the process 300 as well as means for accomplishing other processes in conjunction with other components of the cloud-based storage platform 103.

In step 301, the control logic 201 may determine location information associated with one or more cloud-based repositories that include data associated with at least one user. The control logic 201 may then, at step 303, cause a presentation of a user interface depicting one or more representations of the one or more cloud-based repositories based on the location information. In one scenario, the user interface may depict servers that represent the cloud-based repositories storing the data associated with the user. The servers may, for instance, be rendered on the user interface based on the location information of the cloud-based repositories. By way of example, the location information may include addresses associated with the cloud-based repositories (e.g., street number, street, zip code, city, country, etc.), points of interest that the cloud-based repositories are in or near (e.g., regions, places, points of interest associated with entities of interest, etc.), files of the entities of interest that the cloud-based repositories are near, etc.

In certain embodiments, other cloud-based repositories may also be represented on the user interface along with the representations of the cloud-based repositories storing the data associated with the user. For example, the other cloud-based repositories may represent cloud-based repositories that are near the user's data (e.g., since they are near the closed-based repositories storing the user's data) and store data belonging to the user's social networking friends. In this way, the user may be able to visualize the additional information about her data (e.g., where her data is stored, whose data her data is stored with or near, etc.), which may thus increase the confidence and trust about the data integrity associated with the storage of her data.

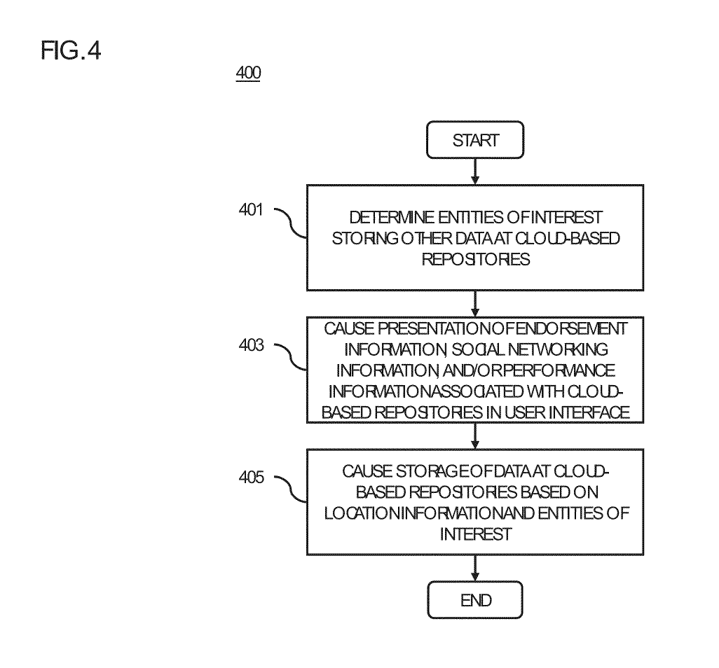

FIG. 4 is a flowchart of a process for storing data based on a location and an entity of interest, according to one embodiment. In one embodiment, the cloud-based storage platform 103 performs the process 400 and is implemented in, for instance, a chip set including a processor and a memory as shown in FIG. 8. As such, the control logic 201 can provide means for accomplishing various parts of the process 400 as well as means for accomplishing other processes in conjunction with other components of the cloud-based storage platform 103.

In step 401, the cloud-based storage platform 103 may determine one or more entities of interest storing other data at the one or more cloud-based repositories. By way of example, the cloud-based storage platform 103 may determine the celebrities, social networking friends of the user, etc., who may respective store their data at the various cloud-based repositories. It is noted, however, that entities of interest is not limited to celebrities and social networking friends, but may refer to any other entities that the user may have interest in.

In step 403, the cloud-based storage platform 103 may then cause a presentation of endorsement information, social networking information, performance information, or a combination thereof associated with the one or more cloud-based repositories in the user interface. As indicated, in some embodiments, the endorsement information, the social networking information, the performance information, or a combination thereof may specify one or more associations between the one or more entities and the one or more cloud-based repositories. The one or more associations may, for instance, include indications that the one or more entities (e.g., the celebrities, the friends, etc.) respective store their data at the one or more cloud-based repositories.

In step 405, the cloud-based storage platform 103 may cause storage of the data at the one or more cloud-based repositories based on the location information and the one or more entities of interest. In one scenario, a user may see an endorsement associated with the one or more entities of interest (e.g., Tom Cruize, Lady Dada, Michael Zackson, etc.) who endorses the one or more cloud-based repositories. The endorsement may, for instance, reveal that an entity of interest stores his files at the one or more cloud-based repositories. As such, the user may select to store the user's data near the files of the entity of interest. Since the one or more cloud-based repositories are determined to be located near those files (e.g., due to the files being stored at those cloud-based repositories), the user's data may be transmitted to the one or more cloud-based repositories for storage (e.g., from the user's device, from other cloud-based repositories, etc.).

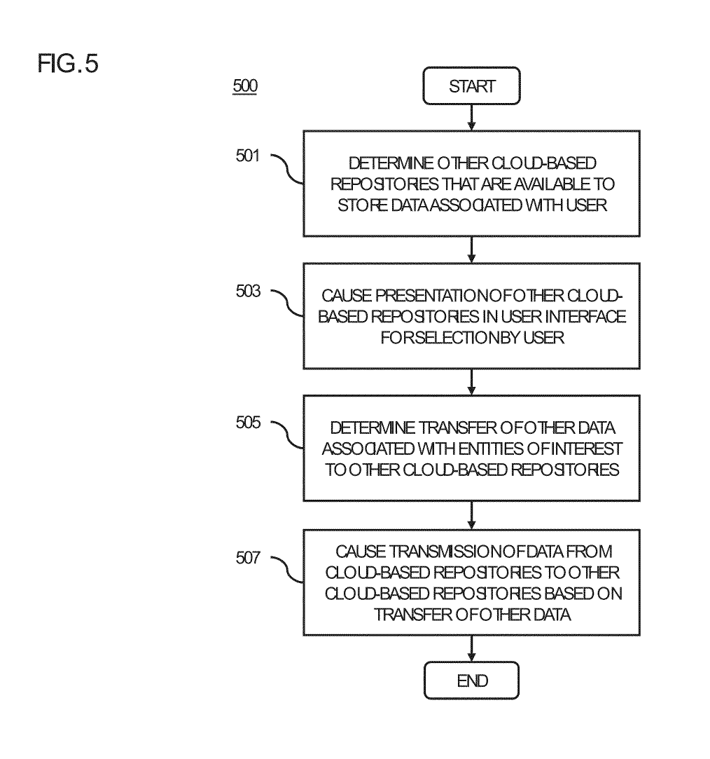

FIG. 5 is a flowchart of a process for transferring data to other cloud-based repositories, according to one embodiment. In one embodiment, the cloud-based storage platform 103 performs the process 500 and is implemented in, for instance, a chip set including a processor and a memory as shown in FIG. 8. As such, the control logic 201 can provide means for accomplishing various parts of the process 500 as well as means for accomplishing other processes in conjunction with other components of the cloud-based storage platform 103.

In step 501, the cloud-based storage platform 103 may determine one or more other cloud-based repositories that are available to store the data. The cloud-based storage platform 103 may then, at step 503, cause a presentation of the one or more other cloud-based repositories in the user interface for selection by the at least one user. By way of example, other cloud-based repositories that may not currently be storing the data associated with the user may be presented to the user as an additional or alternative storage option for the data if, for instance, those other cloud-based repositories have sufficient resources available to store the data. In one use case, the user may select at least one of the other cloud-based repositories for storage of the data, which may result in a transfer of the data from the cloud-based repository (e.g., where the data is currently stored) to the newly selected cloud-based repository.

As indicated, the cloud-based storage platform 103 may also determine a transfer of the other data associated with the one or more entities of interest to the at least one of the one or more other cloud-based repositories (step 505). As such, the cloud-based storage platform 103 may, at step 507, cause a transmission of the data from the one or more cloud-based repositories to the at least one of the one or more other cloud-based repositories based on the transfer of the other data. For example, the user may have selected a setting option that mandates that her cloud-based files stay close to a particular celebrity's cloud-based files. Thus, when the celebrity's files are transferred to another cloud-based repository (e.g., in another location), the user's files may automatically be transferred along with the celebrity's files to the other cloud-based repository.

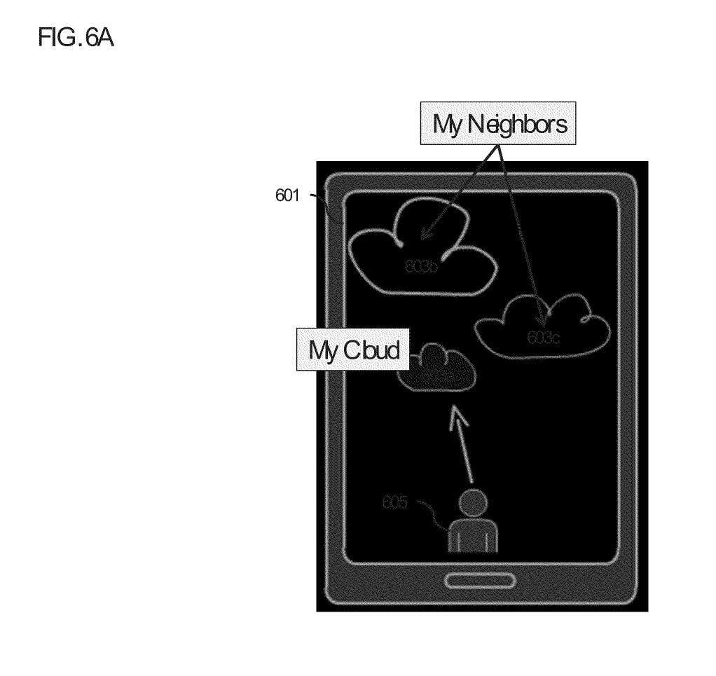

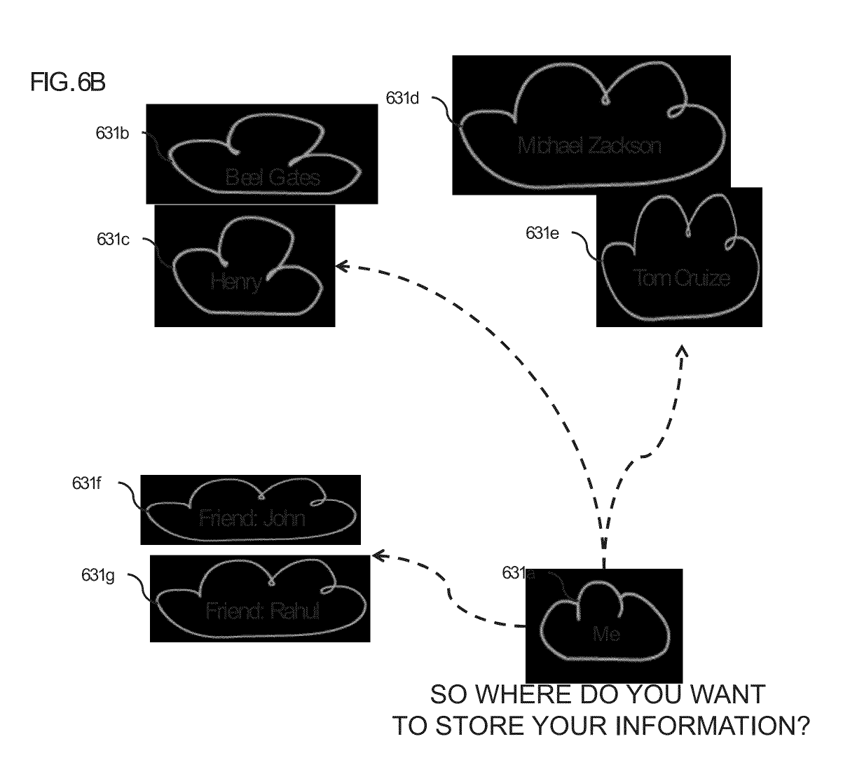

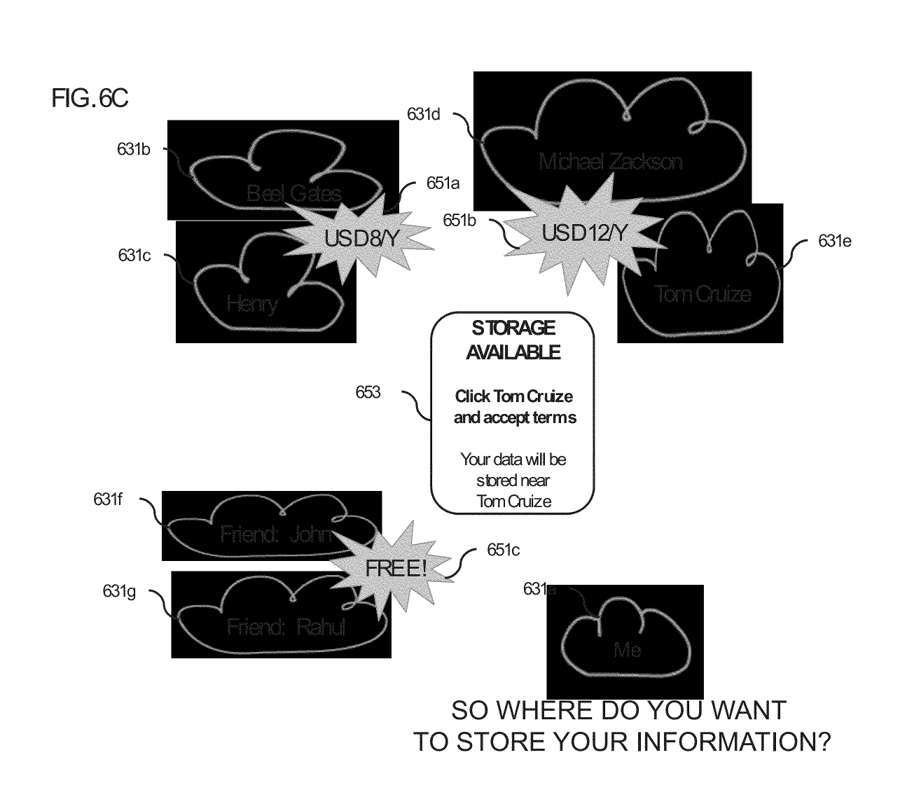

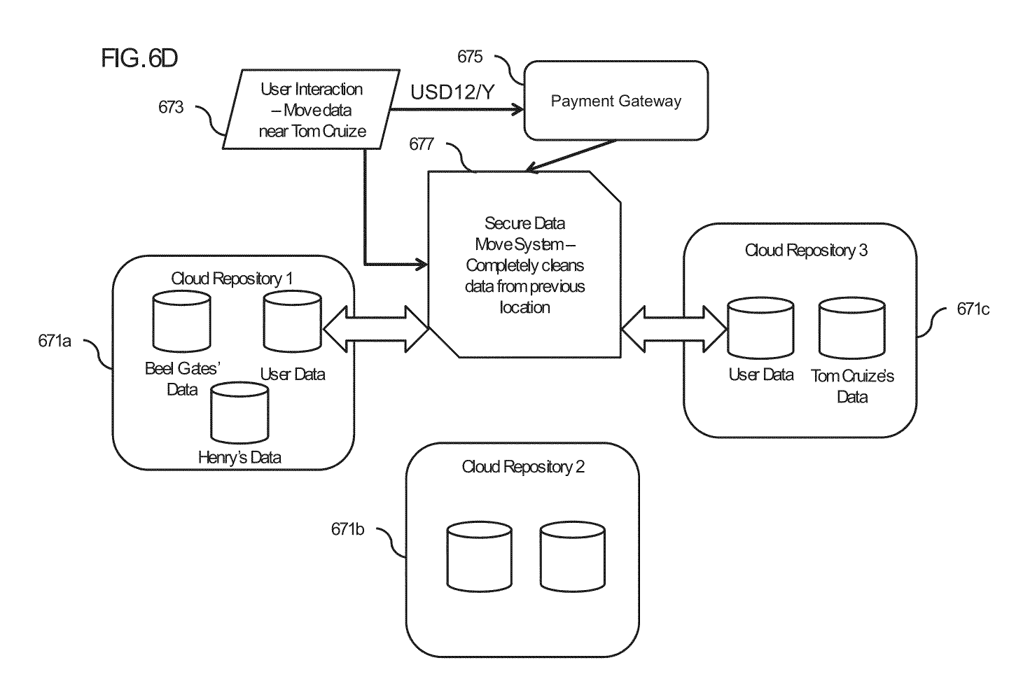

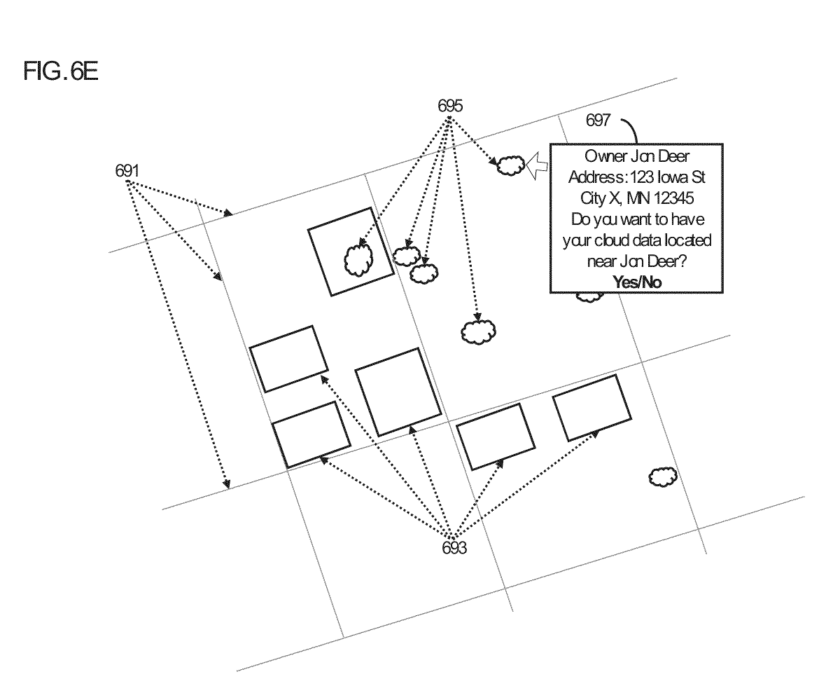

FIGS. 6A-6E are diagrams of scenarios utilizing presentation of cloud-based repositories, according to various embodiments. As shown in FIG. 6A, user interface 601 enables the user to visualize and browse clouds (e.g., clouds 603a-603c) representing cloud-based repositories based on the location information of the cloud-based repositories. As illustrated, the user currently has her data stored at a cloud-based repository represented by the cloud 603a (e.g., as indicated by avatar 605). The other clouds 603b and 603c may, for instance, be depicted on the user interface in relation to the distance of their associated cloud-based repositories to the cloud-based repository represented by the cloud 603a. In this way, transparency of the data storage is increase since the user is able to see where her data is being stored, which may result in increased confidence of the user in the cloud-based storage service. In addition, the presentation of the cloud-based repositories offers cloud-based storage service providers an opportunity to advertise their “cloud colonies” (e.g., cloud-based repositories represented by clouds 603a-603c along with other cloud-based repositories).

FIG. 6B illustrates a depiction (e.g., by user interface 601) of clouds 631a-631g that represent cloud-based repositories where the user and entities of interest store their data. By way of example, files belonging to the user are stored at a cloud-based repository represented by cloud 631a, files belonging to celebrities are respectively stored at cloud-based repositories represented by clouds 631b-631e, and files belonging to the user's friends are respectively stored at cloud-based repositories represented by clouds 631f and 631g. As shown, the clouds 631b-631g demonstrate endorsement information and social networking information associated with the cloud-based repositories that the clouds 631b-631g represent. Cloud 631b, for instance, depicts Beel Gates' name to reveal that Beel Gates endorses the associated cloud-based repository since he stores his files at that cloud-based repository. As such, fans of Bed Gates are more likely to store their files at that cloud-based repository (e.g., to be “closer” to Bed Gates). In addition, in certain embodiments, social networks may be mined to extract relationships (e.g., associated with the user) that may be utilized to propose storage locations to the user (e.g., the social network information depicted in clouds 631f and 631g may be the result of such mining). The user may, for instance, browse the clouds (e.g., clouds 631a-631e and other clouds) to determine whether she would like to keep her files at the cloud-based repository represented by cloud 631a, if she would like to store her files at another cloud-based repository that might be closer to a particular celebrity or friend, etc.

FIG. 6C illustrates presentation of payment information associated with the entities of interest. By way of example, payment information 651a reveals that storing data at cloud-based repositories where Beel Gates or Henry stores their files is $8 per year, payment information 651b reveals that storing data at cloud-based repositories where Michael Zackson and Tom Cruize stores their files is $12 per year, and payment information 651c reveals that storing data at cloud-based repositories where the user's friends store their files is free. As indicated, the user may utilize the payment information while she browses the clouds (e.g., clouds 631a-631e and other clouds) to determine whether she would like to keep her files at the cloud-based repository represented by cloud 631a, if she would like to store her files at another cloud-based repository that might be closer to a particular celebrity or friend, etc. In this scenario, notification 653 demonstrates that the cloud-based repository currently storing Tom Cruize's files is available to store the user's data, and that the user may transfer her data from her current cloud-based repository to the cloud-based repository storing Tom Cruize's files by clicking Tom Cruize's cloud (e.g., cloud 631e) and accepting the terms associated with storage at that cloud-based repository.

FIG. 6D illustrates an example implementation for transferring data of the user from one cloud-based repository to another cloud-based repository (e.g., cloud-based repositories 671a-671c). In this scenario, the user's selection of Tom Cruize's cloud and acceptance of the storage terms (e.g., user interaction 673) may result in the charging of the user's account (e.g., $12 per year) based on the payment information 651b associated with Tom Cruize at payment gateway 675. Secure data move system 677 may then transfer the user's data from cloud-based repository 671a to cloud-based repository 671c so that the user's data will be stored at the same cloud-based repository as Tom Cruize's data. In addition, as shown, the secure data move system 677 may completely clean the user's data from cloud-based repository 671a as a result of the user interaction 673.

FIG. 6E illustrates a diagram of a map user interface that includes various streets 691, buildings 693, and clouds 695 representing cloud repositories that store user cloud data. In one scenario, a user's cloud repository address may, for instance, be identical with the street addresses and/or names of the cloud repository storing a celebrity's cloud data (e.g., indicating that the user's cloud data and the celebrity's cloud data are stored near each other). Using the map user interface, users can search for friends, celebrities, etc., to find the addresses of the cloud repositories that store the data belonging to those friends, celebrities, etc.

As shown, a search for “Jon Deer” may produce the depiction of the various streets 691, buildings 693, and clouds 695. In addition, the search may produce a notification 697 with an arrow that indicates the address of the cloud repository storing Jon Deer's cloud data and the particular cloud 695 representing that cloud repository. As illustrated, the user may select an option on the notification 697 to “move” his cloud data to a cloud repository near the cloud repository storing Jon Deer's cloud data. If, for instance, the user selects to “move” his cloud data near Jon Deer's cloud data, the user interface may be updated to depict the user's data at Jon Deer's the cloud repository, or at a cloud repository associated with an address near the address associated with Jon Deer's cloud repository (e.g., the user's cloud repository may be given the address 122 Iowa Street, City X, Minn. 12345, and Jon Deer's cloud repository may continue to have the address 123 Iowa Street, City X, Minn. 12345)

In certain embodiments, “cloud” data may be stored as metadata for buildings and other points of interests. As such, when a user clicks a point of interest on the map user interface, the map user interface may present the user with data indicating all of the users that are currently storing data near the selected point of interest along with information about the cloud repositories at which the data is stored. In some embodiments, users may activate a “cloud view” to depict representations of the cloud repositories over a map that may, for instance, enable those users to search for cloud repositories. In other embodiments, the points of interest may have addresses of cloud repositories and the points of interest can serve as the cloud address. The use of the map user interface during navigation may, for instance, provide user suggestions to use points of interests, streets, etc., as virtual addresses for their cloud repositories. In various embodiments, users can obtain their own icon for cloud services from map services that can provide addresses of people, points of interest information/addresses as selectable items to cloud repositories, etc.

The processes described herein for presenting cloud-based repositories based on location information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

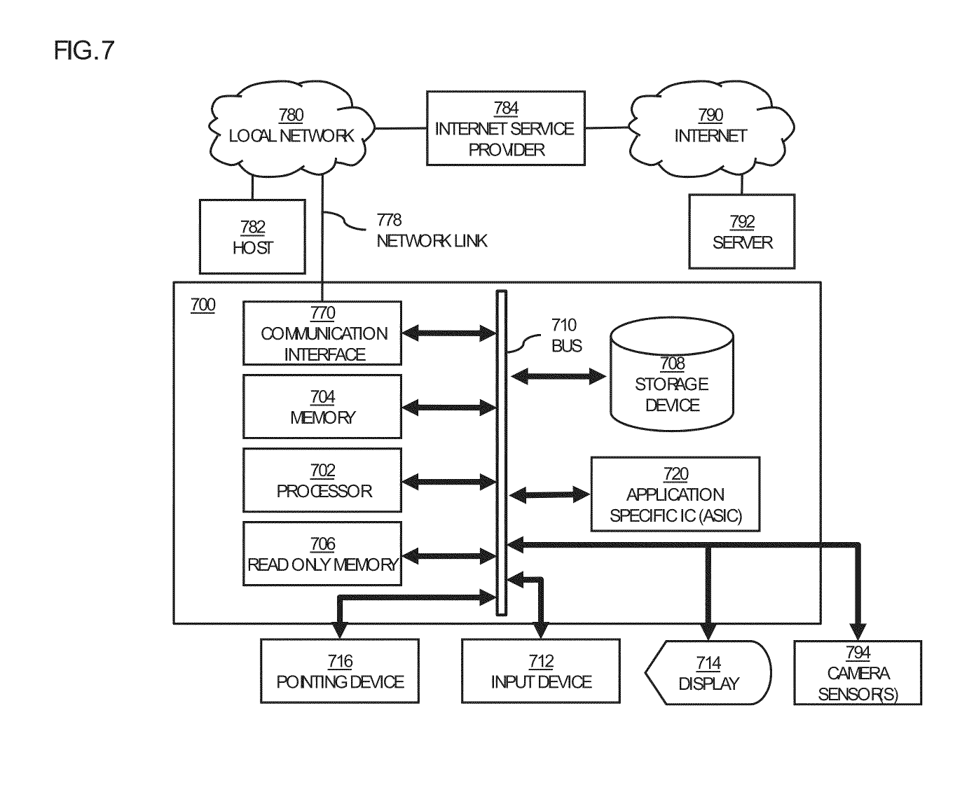

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to present cloud-based repositories based on location information as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of presenting cloud-based repositories based on location information.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to presenting cloud-based repositories based on location information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 700 also includes a memory 704 coupled to bus 710. The memory 704, such as a random access memory (RAM) or any other dynamic storage device, stores information including processor instructions for presenting cloud-based repositories based on location information. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for presenting cloud-based repositories based on location information, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714, and one or more camera sensors 794 for capturing, recording and causing to store one or more still and/or moving images (e.g., videos, movies, etc.) which also may comprise audio recordings. In some embodiments, for example, in embodiments in which the computer system 700 performs all functions automatically without human input, one or more of external input device 712, display device 714 and pointing device 716 may be omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for presenting cloud-based repositories based on location information to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to present cloud-based repositories based on location information as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of presenting cloud-based repositories based on location information.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to present cloud-based repositories based on location information. The memory 805 also stores the data associated with or generated by the execution of the inventive steps.

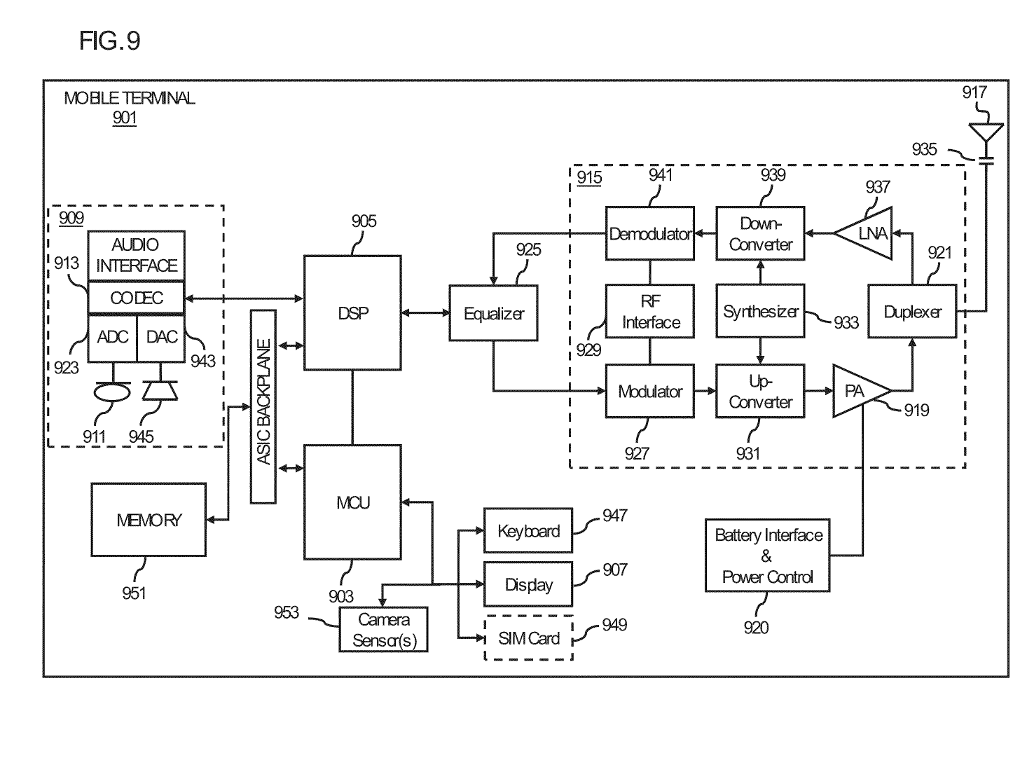

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of presenting cloud-based repositories based on location information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of presenting cloud-based repositories based on location information. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to present cloud-based repositories based on location information. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

Further, one or more camera sensors 953 may be incorporated onto the mobile station 901 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

We claim:

1. A method comprising facilitating a processing of and/or processing (1) data and/or (2) information and/or (3) at least one signal, the (1) data and/or (2) information and/or (3) at least one signal based, at least in part, on the following:
at least one determination of location information associated with one or more cloud-based repositories that include data associated with at least one user; and
a presentation of a user interface depicting one or more representations of the one or more cloud-based repositories based, at least in part, on the location information.

2. A method of claim 1, wherein the (1) data and/or (2) information and/or (3) at least one signal are further based, at least in part, on the following:
a storage of the data at the one or more cloud-based repositories based, at least in part, on the location information.

3. A method of claim 2, wherein the (1) data and/or (2) information and/or (3) at least one signal are further based, at least in part, on the following:
at least one determination of one or more entities of interest storing other data at the one or more cloud-based repositories,
wherein the storage of the at least a portion at the one or more cloud-based repositories is further based, at least in part, on the one or more entities of interest.

4. A method of claim 3, wherein the (1) data and/or (2) information and/or (3) at least one signal are further based, at least in part, on the following:
a presentation of endorsement information, social networking information, performance information, or a combination thereof associated with the one or more cloud-based repositories in the user interface.

5. A method of claim 4, wherein the endorsement information, the social networking information, the performance information, or a combination thereof specify, at least in part, one or more associations between the one or more entities and the one or more cloud-based repositories.

6. A method of claim 3, wherein the (1) data and/or (2) information and/or (3) at least one signal are further based, at least in part, on the following:
at least one determination of one or more other cloud-based repositories that are available to store the data; and
a presentation of the one or more other cloud-based repositories in the user interface for selection by the at least one user.

7. A method of claim 6, wherein the (1) data and/or (2) information and/or (3) at least one signal are further based, at least in part, on the following:
a transmission of the data from the one or more cloud-based repositories to at least one of the one or more other cloud-based repositories.

8. A method of claim 7, wherein the (1) data and/or (2) information and/or (3) at least one signal are further based, at least in part, on the following:
at least one determination of an input for selecting the at least one of the one or more other cloud-based repositories,
wherein the transmission is based, at least in part, on the selection input.

9. A method of claim 7, wherein the (1) data and/or (2) information and/or (3) at least one signal are further based, at least in part, on the following:
at least one determination of a transfer of the other data associated with the one or more entities of interest to the at least one of the one or more other cloud-based repositories,
wherein the transmission is based, at least in part, on the transfer of the other data.

10. A method of claim 3, wherein the (1) data and/or (2) information and/or (3) at least one signal are further based, at least in part, on the following:
at least one determination of payment information associated with the one or more entities of interest, the location information, or a combination thereof; and
at least one determination to charge for the storage at the one or more cloud-based repositories based, at least in part, on the payment information.

11. A method of claim 2, wherein the (1) data and/or (2) information and/or (3) at least one signal are further based, at least in part, on the following:
at least one determination of one or more requests to store the data at the one or more cloud-based repositories based, at least in part, on a determination that at least one event will utilize stored data at the one or more cloud-based repositories.

12. An apparatus comprising:
at least one processor; and
at least one memory including computer program code for one or more programs,
the at least one memory and the computer program code configured to, with the at least one processor, cause the apparatus to perform at least the following,
determine location information associated with one or more cloud-based repositories that include data associated with at least one user; and
cause, at least in part, a presentation of a user interface depicting one or more representations of the one or more cloud-based repositories based, at least in part, on the location information.

13. An apparatus of claim 12, wherein the apparatus is further caused to:
cause, at least in part, a storage of the data at the one or more cloud-based repositories based, at least in part, on the location information.

14. An apparatus of claim 13, wherein the apparatus is further caused to:
determine one or more entities of interest storing other data at the one or more cloud-based repositories,
wherein the storage of the at least a portion at the one or more cloud-based repositories is further based, at least in part, on the one or more entities of interest.

15. An apparatus of claim 14, wherein the apparatus is further caused to:
cause, at least in part, a presentation of endorsement information, social networking information, performance information, or a combination thereof associated with the one or more cloud-based repositories in the user interface.

16. An apparatus of claim 15, wherein the endorsement information, the social networking information, the performance information, or a combination thereof specify, at least in part, one or more associations between the one or more entities and the one or more cloud-based repositories.

17. An apparatus of claim 14, wherein the apparatus is further caused to:
determine one or more other cloud-based repositories that are available to store the data; and
cause, at least in part, a presentation of the one or more other cloud-based repositories in the user interface for selection by the at least one user.

18. An apparatus of claim 17, wherein the apparatus is further caused to:
cause, at least in part, a transmission of the data from the one or more cloud-based repositories to at least one of the one or more other cloud-based repositories.

19. An apparatus of claim 18, wherein the apparatus is further caused to:
determine an input for selecting the at least one of the one or more other cloud-based repositories,
wherein the transmission is based, at least in part, on the selection input.

20. An apparatus of claim 18, wherein the apparatus is further caused to:
determine a transfer of the other data associated with the one or more entities of interest to the at least one of the one or more other cloud-based repositories,
wherein the transmission is based, at least in part, on the transfer of the other data.

21. An apparatus of claim 14, wherein the apparatus is further caused to:
determine payment information associated with the one or more entities of interest, the location information, or a combination thereof; and
determine to charge for the storage at the one or more cloud-based repositories based, at least in part, on the payment information.

22. An apparatus of claim 13, wherein the apparatus is further caused to:
determine one or more requests to store the data at the one or more cloud-based repositories based, at least in part, on a determination that at least one event will utilize stored data at the one or more cloud-based repositories.

23. A computer-readable storage medium carrying one or more sequences of one or more instructions which, when executed by one or more processors, cause an apparatus to at least perform a method comprising:
determining location information associated with one or more cloud-based repositories that include data associated with at least one user; and
causing, at least in part, a presentation of a user interface depicting one or more representations of the one or more cloud-based repositories based, at least in part, on the location information.
